(19) United States
(12) Patent Application Publication
(10) Pub. No.: US 2016/0381723 A1
(43) Pub. Date: Dec. 29, 2016

(54) COMMUNICATION SYSTEM, SERVER, METHOD USED IN THE COMMUNICATION SYSTEM AND THE SERVER, AND PROGRAM USED IN THE COMMUNICATION SYSTEM AND THE SERVER

(71) Applicant: PANASONIC INTELLECTUAL PROPERTY MANAGEMENT CO., LTD., Osaka (JP)

(72) Inventor: Yuichi MIYAKE, Kanagawa (JP)

(21) Appl. No.: 15/260,168

(22) Filed: Sep. 8, 2016

Related U.S. Application Data
(63) Continuation of application No. PCT/JP2014/003270, filed on Jun. 18, 2014.

(30) Foreign Application Priority Data
Mar. 12, 2014 (JP) 2014-049480

(51) Int. Cl. H04W 76/02; H04W 12/08

(52) U.S. Cl. CPC H04W 76/021; H04W 12/08; H04W 88/08

(57) ABSTRACT

A communication system is provided which includes a server and first and second terminals capable of communicating with the server. The first terminal includes a first acquisition unit configured to acquire first identifier information for a given communication device. The second terminal includes a second acquisition unit configured to acquire second identifier information for a communication device capable of wirelessly communicating with the second terminal. The server includes a comparator that compares the first and second identifier information and, using a result of the comparison, determines whether or not to authorize communication between the first and second terminals. When the comparator authorizes communication between the first and second terminals, the comparator transmits, to at least one of the first terminal and the second terminal, information to be used for communicating with the other.

### CROSS REFERENCE TO RELATED APPLICATIONS

This is a continuation application of PCT International Application No. PCT/JP2014/003270 filed on Jun. 18, 2014, designating the United States of America, which is based on and claims priority of Japanese Patent Application No. 2014-049480 filed on Mar. 12, 2014. The entire disclosures of the above-identified applications, including the specifications, drawings and claims are incorporated herein by reference in their entirety.

### FIELD

The present disclosure relates to a communication system, a server, a terminal, and a method and program used by the communication system, the server, and the terminal.

### BACKGROUND

Patent Literature (PTL) 1 discloses a verification method using GPS information for rapidly and easily exchanging information between two communication devices when the communication devices are in approximately the same place at the same time. In the verification method disclosed in PTL 1, when each of the two communication devices located in approximately the same place requests to communicate with the other, both of the communication devices acquire positional information via GPS, and transmit the positional information to a server, which then performs the verification for communication between the two communication device on the basis of the positional information. With this, communication verification between two communication devices can be completed without a user having to input, for example, identification information into the communication devices.

35

### CITATION LIST

### Patent Literature

[PTL 1] U.S. Pat. No. 8,577,292

### SUMMARY

### Technical Problem

The present disclosure provides a communication system and the related technologies capable of determining whether or not to authorize communication between a plurality of terminals with little user operation required.

### Solution to Problem

The communication system according to this disclosure includes: a server; a first terminal capable of communicating with the server; and a second terminal capable of communicating with the server. The first terminal includes a first acquisition unit configured to acquire first identifier information for a given communication device. The second terminal includes a second acquisition unit configured to acquire second identifier information for a communication device capable of wirelessly communicating with the second terminal. The server includes: a first receiver that receives the first identifier information from the first terminal; a second receiver that receives the second identifier information from the second terminal; and a comparator that compares the first identifier information and the second identifier information and, using a result of the comparison, determines whether or not to authorize communication between the first terminal and the second terminal. When the comparator determines to authorize communication between the first terminal and the second terminal, the comparator transmits, to at least one of the first terminal and the second terminal, information to be used for communicating with the other of the first terminal and the second terminal.

### Advantageous Effects

The communication system and the related technologies according to the present disclosure are effective in determining whether or not to authorize communication between a plurality of terminals with little user operation required.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 schematically illustrates a configuration of a communication system according to Embodiment 1,

FIG. 2 is a block diagram illustrating a functional configuration of the communication system according to Embodiment 1.

FIG. 3 is a sequence chart illustrating procedures for performing communication between a first terminal and a second terminal in the communication system according to Embodiment 1.

FIG. 4 is a block diagram illustrating a functional configuration of a communication system according to Embodiment 2.

FIG. 5 is a sequence chart illustrating procedures for performing communication between a first terminal and a second terminal in the communication system according to Embodiment 2.

FIG. 6 is a block diagram illustrating a functional configuration of a communication system according to Embodiment 3.

FIG. 7 is a sequence chart illustrating procedures for performing communication between a first terminal and a second terminal in the communication system according to Embodiment 3.

### DESCRIPTION OF EMBODIMENTS

Hereinafter, embodiments will be described in detail with reference to the drawings. Note that overly detailed descriptions may be omitted. For example, descriptions of known techniques or duplicate descriptions of essentially the same elements may be omitted. This is to avoid unnecessary redundancy and provide easy to read descriptions for those skilled in the art.

Note that the inventor has provided the attached drawings and the following description in order to facilitate sufficient understanding of the present disclosure by those skilled in the art.

### Embodiment 1

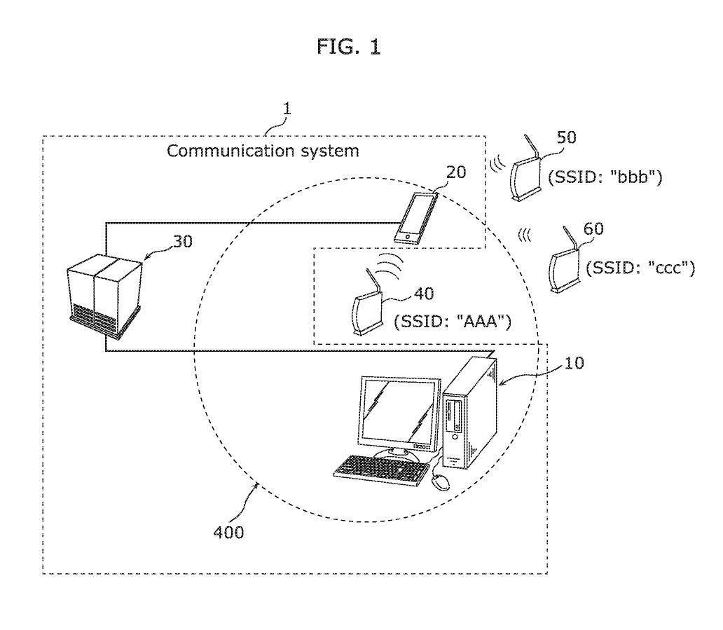

Hereinafter, the communication system according to Embodiment 1 will be described with reference to FIG. 1 through FIG. 3.

### (1-1. Configuration)

### (1-1-1. Outline of Communication System)

FIG. 1 schematically illustrates a configuration of the communication system according to this embodiment.

As illustrated in FIG. 1, the communication system 1 according to this embodiment includes a first terminal 10, a second terminal 20, and a server 30. In the communication system 1 according to this embodiment, for example, a first communication device 40, a second communication device 50, and a third communication device 60, which are located near the devices included in the communication system 1, are used.

The first terminal 10 and the second terminal 20 illustrated in FIG. 1 are terminals capable of communicating with the server 30, and are, for example, personal computers (PCs) or smart phones. The communication line between the first terminal 10 and the server 30 and the second terminal 20 and the server 30 is not particularly limited, and may be, for example a wired or wireless local area network (LAN).

The server 30 illustrated in FIG. 1 is a computer capable of communicating with the first terminal 10 and the second terminal 20. The server 30 receives requests from the first terminal 10 and the second terminal 20, and determines whether or not to authorize communication between the first terminal 10 and the second terminal 20. When the server 30 determines to authorize communication between the first terminal 10 and the second terminal 20, at least one of the first terminal 10 and the second terminal 20 transmits information required for communication to the other.

The first communication device 40, the second communication device 50, and the third communication device 60 illustrated in FIG. 1 are wireless communication devices located near the devices included in the communication system 1. The first communication device 40, the second communication device 50, and the third communication device 60 are not particularly limited to a given example, and may be, for example, wireless LAN access points. The first communication device 40, the second communication device 50, and the third communication device 60 not elements included in the communication system 1, but are rather used only for the purpose of determining whether or not to authorize communication between the first terminal 10 and the second terminal 20. For example, the first communication device 40, the second communication device 50, and the third communication device 60 may be wireless LAN access points, and may broadcast service set identifiers (SSIDs) such as “AAA”, “bbb”, and “ccc” as unique identifiers. Here, in the communication system 1 according to this embodiment, authorizing communication between the first terminal 10 and the second terminal 20 is determined on the basis of whether the SSID “AAA” broadcast by the first communication device 40 is receivable by the second terminal 20 or not (or whether the second terminal 20 is within an area 400 in which the second terminal 20 is capable of receiving a signal from the first communication device 40 illustrated in FIG. 1). With this, only those terminals that are near the first communication device 40 can be selectively authorized to communicate with first terminal 10.

The communication system 1 according to this embodiment can be applied in cases in which, for example, the server 30, which is capable of communicating with the first terminal 10 and the second terminal 20, is caused to authorize communication between the first terminal 10 and the second terminal 20 in order for data stored on the first terminal 10 to be transmitted to the second terminal 20. For example, the communication system 1 according to this embodiment can be applied in a lecture room in which a lecturer gives a lecture while providing the audience with lecture material using a display of the first terminal 10 and transmits the lecture material data to the second terminals 20 used by the audience members.

### (1-1-2. Communication System Functions)

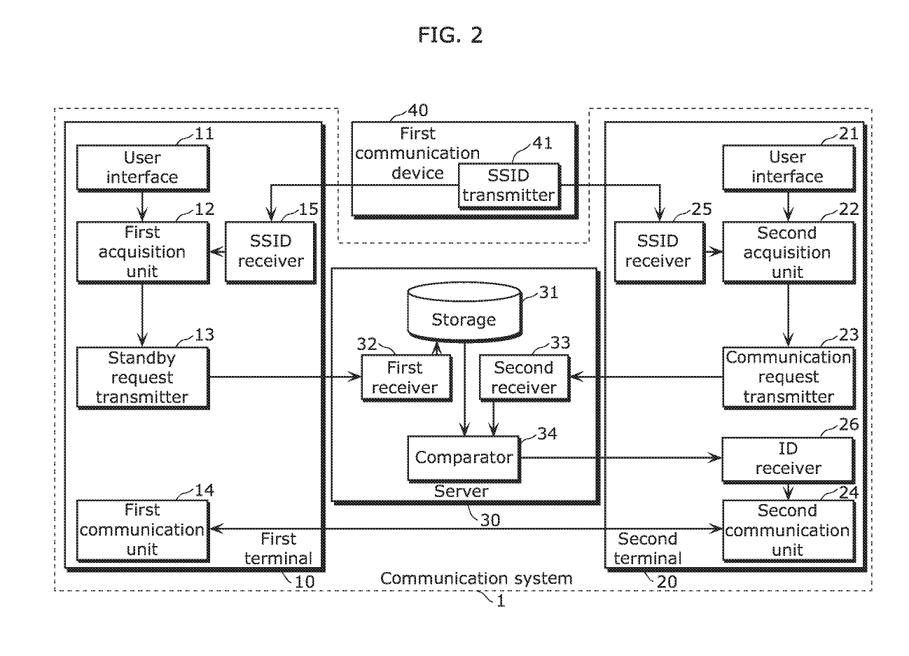

Next, functions performed by the communication system 1 according to Embodiment 1 will be described with reference to FIG. 2.

FIG. 2 is a block diagram illustrating characterizing functions performed by the communication system 1 according to this embodiment.

As illustrated in FIG. 2, the first terminal 10 functionally includes a user interface 11, a first acquisition unit 12, a standby request transmitter 13, a first communication unit 14, and an SSID receiver 15.

Second terminal 20 functionally includes a user interface 21, a second acquisition unit 22, a communication request transmitter 23, a second communication unit 24, an SSID receiver 25, and an ID receiver 26.

The server 30 functionally includes a storage 31, a first receiver 32, a second receiver 33, and a comparator 34.

Note that here, the first communication device 40 used in the communication system 1 is exemplified as a wireless LAN access point. The first communication device 40 functionally includes an SSID transmitter 41. The SSID transmitter 41 is a processing unit that transmits a signal including an SSID (“AAA”) assigned to the first communication device 40. Moreover, as illustrated in FIG. 2, although the first communication device 40 used by the communication system 1 is illustrated as the only communication device near the communication system 1, usually more than one communication device (the second communication device 50, the third communication device 60, etc.) is present near the communication system 1.

The user interface 11 of the first terminal 10 and the user interface 21 of the second terminal 20 are input units for receiving inputs made by users of the first terminal 10 and the second terminal 20. Examples of the user interface 11 and the user interface 21 include a keyboard, mouse, and a touch panel.

The first acquisition unit 12 of the first terminal 10 is a processing unit that receives a signal input via the user interface 11 and an SSID input from the SSID receiver 15 and outputs the signal and the SSID to the standby request transmitter 13.

The standby request transmitter 13 of the first terminal 10 is a processing unit that transmits, to the server 30, a signal including the SSID input from the first acquisition unit 12 and ID information for the first terminal 10. Here, ID information for the first terminal 10 is identification information used for the second terminal 20 to communicate with the first terminal 10.

The first communication unit 14 of the first terminal 10 is a communication unit for performing data communication when communication with the second terminal 20 is authorized by the server 30.

The SSID receiver 15 of the first terminal 10 is a processing unit that receives the SSID transmitted from a nearby wireless LAN access point and outputs the received SSID to the first acquisition unit 12.

The second acquisition unit 22 of the second terminal 20 is a processing unit that receives a signal input via the user interface 21 and an SSID input from the SSID receiver 25 and outputs the signal and the SSID to the communication request transmitter 23.

The communication request transmitter 23 of the second terminal 20 is a processing unit that transmits, to the server 30, the SSID input from the second acquisition unit 22.

The SSID receiver 25 of the second terminal 20 is a processing unit that receives the SSID transmitted from a nearby wireless LAN access point and outputs the received SSID to the second acquisition unit 22.

The ID receiver 26 of the second terminal 20 is a processing unit for receiving ID information for communicating with the first terminal 10 from the server 30 and outputting the received ID information to the second communication unit 24 when communication with the first terminal 10 is authorized by the server 30.

The second communication unit 24 of the second terminal 20 is a processing unit for performing data communication with the first terminal 10 using information on the first terminal 10 input from the ID receiver 26.

The first receiver 32 of the server 30 is a processing unit that receives a signal transmitted from the standby request transmitter 13 of the first terminal 10, and outputs the received signal to the storage 31.

The second receiver 33 of the server 30 is a processing unit that receives a signal including an SSID transmitted from the communication request transmitter 23 of the second terminal 20, and outputs the received signal to the comparator 34.

The storage 31 of the server 30 is a storage that stores an SSID input from the first receiver 32 and ID information on the first terminal 10, and outputs the stored information to the comparator 34. The storage 31 is, for example, a memory or hard disk.

The comparator 34 of the server 30 is a processing unit that compares the SSID input from the storage 31 and the SSID input from the second receiver 33, and when the SSIDs match, transmits the ID information on the first terminal 10 to the second terminal 20.

### (1-2. Operations)

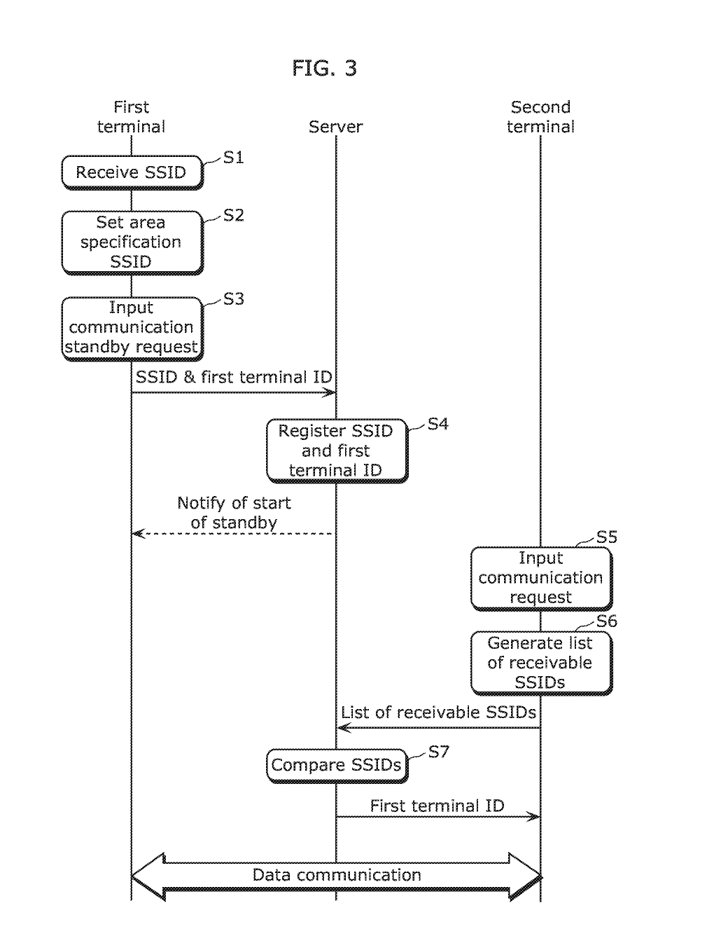

Next, operations performed by the above-described communication system 1 will be described with reference to FIG. 3.

FIG. 3 is a sequence chart illustrating procedures for performing communication between the first terminal 10 and the second terminal 20 in the communication system 1.

First, when communication is to be performed between the first terminal 10 and the second terminal 20, an area in which terminals are authorized to communicate with the first terminal 10 is specified. In order to do so, first identifier information, which is identifier information for a given communication device located near the first terminal 10 and the second terminal 20, is set. In this example, the SSID (“AAA”) of the first communication device 40, which is the identifier information for the first communication device 40, is set in the first terminal 10 as the first identifier information. The SSID of the first communication device 40 is received by the SSID receiver 15 of the first terminal 10 (S1), and is set as an area specification SSID by being selected from the SSIDs input into the first acquisition unit 12 (S2). The user interface 11 is used when selecting an SSID from among the SSIDs input into the first acquisition unit 12. Alternatively, the SSID may be directly input into the user interface 11 without using the SSID receiver 15.

In the first terminal 10, when the area specification SSID is set, that SSID is output to the standby request transmitter 13. Then, a signal for placing the first terminal 10 in standby to communicate with a terminal receiving that SSID is input from the user interface 11 (S3). When that signal is input into the standby request transmitter 13, a signal including the area specification SSID and the ID information on the first terminal 10 is transmitted to the server 30, and the server 30 is notified of a standby request for communication with the terminal receiving that SSID.

When the area specification SSID and the ID information on the first terminal 10 are transmitted to the server 30, the server 30 registers that SSID and the ID information on the first terminal 10 in the storage 31 (S4). Then, after the registering is complete, the server 30 transmits, to the first terminal 10, a signal indicating that standby has begun.

When receipt of the signal indicating that standby has begun is confirmed in the first terminal 10, processing transitions to second terminal 20 side processes.

On the second terminal 20 side, a signal indicating a request for communication is input from the user interface 21 (S5). When that signal is input into the second acquisition unit 22, the second acquisition unit 22 acquires second identifier information, which is identifier information for a communication device capable of wirelessly communicating with the second terminal 20. Here, a list of SSIDs capable of being received by SSID receiver 25 is generated and transmitted to the server 30 as the second identifier information (S6). The list is generated on the basis of SSIDs input into the second acquisition unit 22 from the SSID receiver 25, and for example, includes SSIDs of the first communication device 40, the second communication device 50, and the third communication device 60 illustrated in FIG. 1 (“AAA”, “bbb”, and “ccc”).

The second receiver 33 of the server 30 receives the list of SSIDs capable of being received by the second terminal 20, and outputs the list to the comparator 34. Then, the comparator 34 compares SSIDs to determine whether the area specification SSID (“AAA”) input from the storage 31 is in the list of SSIDs capable of being received by the second terminal 20 (S7). Here, if the area specification SSID is in the list of SSIDs capable of being received by the second terminal 20, the comparator 34 transmits, to the second terminal 20, the ID information on the first terminal 10 input from the storage 31. If the area specification SSID is not in the list of SSIDs capable of being received by the second terminal 20, the comparator 34 does not transmit the ID information to the second terminal 20 or transmits, to the second terminal 20, a signal indicating that the area specification SSID is not in the list of SSIDs capable of being received.

When the second terminal 20 receives the ID information on the first terminal 10, the second communication unit 24 can perform data communication with the first communication unit 14 of the first terminal 10 using the ID information.

In the above description, the communication system 1 is exemplified as including only one second terminal 20, but the communication system 1 may include a plurality of second terminals 20. Moreover, in cases in which, for example, a terminal that should not be authorized to communicate with first terminal 10 is capable of receiving the area specification SSID, the number of second terminals 20 that are to be authorized to communicate with the first terminal 10 may be limited to a supposable number determined in advance. This makes it possible to sufficiently limit the terminals that are to be authorized to communicate with the first terminal 10.

The ID information on the first terminal 10 is not particularly limited, and may be identification information that makes it possible to achieve communication between the first terminal 10 and the second terminal 20. For example, the ID information may be an IP address or an electronic mail address.

Moreover, in this embodiment, a configuration in which the ID information on the first terminal 10 is transmitted to the second terminal 20 is used in order to perform communication between the first terminal 10 and the second terminal 20, but a configuration in which ID information on the second terminal 20 is transmitted to the first terminal 10 may be used. A configuration in which ID information is transmitted in both directions between the first terminal 10 and the second terminal 20 may also be used.

Note that, as described above, the area specification SSID may be directly set in the first terminal 10 via the user interface 11. As such, the SSID receiver 15 in the first terminal 10 is an optional element. Furthermore, when communication between the first terminal 10 and the second terminal 20 is conducted over a wired line, the first terminal 10 need not include a wireless LAN communication function.

### (1-3. Advantageous Effects, etc.)

As described above, the communication system 1 according to this embodiment includes the server 30, the first terminal 10 capable of communicating with the server 30, and the second terminal 20 capable of communicating with the server 30. Here, the first terminal 10 includes the first acquisition unit 12 that acquires first identifier information, which is identifier information for a given communication device, and the second terminal 20 includes the second acquisition unit 22 that acquires second identifier information, which is identifier information for a communication device capable of wirelessly communicating with the second terminal 20. Moreover, the server 30 includes: the first receiver 32 that receives the first identifier information from the first terminal 10; the second receiver 33 that receives the second identifier information from the second terminal 20; and the comparator 34 that compares the first identifier information and the second identifier information and, using the result of the comparison, determines whether or not to authorize communication between the first terminal 10 and the second terminal 20. When the comparator 34 determines to authorize communication between the first terminal 10 and the second terminal 20, the comparator 34 transmits, to at least one of the first terminal 10 and the second terminal 20, information to be used for communicating with the other of the first terminal 10 and the second terminal 20.

With this configuration, in the communication system 1 according to this embodiment, whether to authorize or refuse communication can be determined without having to input the ID information for each terminal from the user interface 11 of the first terminal 10 and the user interface 21 of the second terminal 20. Moreover, when communication is authorized, since information to be used for communication is sent from the server 30, communication between two terminals can start without having to input, from the user interface, information to be used for communication.

Moreover, in the communication system 1, since a communication device that performs wireless communication is used, this configuration can be used either inside or outside a building.

Moreover, a terminal included in the communication system 1 according to this embodiment is, for example, a terminal capable of wireless communication via, for example, a wireless LAN. As such, a versatile communication device, such as a PC or a smart phone, may be used as the terminal.

Moreover, in the communication system 1 according to this embodiment, the second identifier information can include identifier information for a plurality communication devices capable of wirelessly communicating with the second terminal.

With this configuration, even when identifier information such as an SSID not used by the communication system 1 for determining whether to authorize communication or not is included in the second identifier information, the communication system 1 can be used.

Thus, even when multiple communication devices are present near the communication system 1, the communication system 1 can be used.

Moreover, in the communication system 1 according to this embodiment, the first identifier information and the second identifier information may each include identifier information for an access point.

With this configuration, the SSID, which is identifier information that the access point continuously broadcasts, can be used to determine whether or not to authorize communication.

Moreover, by using the SSID of an access point as the identifier information, a versatile communication device, such as a PC or a smart phone, may be used as a terminal included in the communication system 1.

Moreover, in the communication system 1, the second terminal 20 may include a plurality of second terminals 20, and the server 30 may determine to authorize communication between the first terminal 10 and a given number of the plurality of second terminals 20.

This configuration makes it possible to reduce the possibility of communication being authorized between the first terminal 10 and a terminal that should not be authorized to communicate with the first terminal 10, and sufficiently limit the terminals that can communicate with the first terminal 10.

Moreover, the server 30 according to this embodiment is communicably connected to the first terminal 10 and the second terminal 20. The server 30 includes: the first receiver 32 that receives, from the first terminal 10, first identifier information for a given communication device; the second receiver 33 that receives, from the second terminal 20, second identifier information for a communication device capable of wirelessly communicating with the second terminal 20; and the comparator 34 that compares the first identifier information and the second identifier information and, using a result of the comparison, determines whether or not to authorize communication between the first terminal 10 and the second terminal 20. When the comparator 34 determines to authorize communication between the first terminal 10 and the second terminal 20, the comparator 34 transmits, to at least one of the first terminal 10 and the second terminal 20, information to be used for communicating with the other of the first terminal 10 and the second terminal 20.

With this configuration, the same advantages effects as described regarding the communication system 1 can be achieved.

Moreover, a method of determining, in the server 30, whether or not to authorize communication between the first terminal 10 capable of communicating with the server 30 and the second terminal 20 capable of communicating with the server 30, includes: receiving first identifier information for a given communication device and second identifier information for a communication device capable of wirelessly communicating with the second terminal 20; comparing the first identifier information and the second identifier information; and determining whether or not to authorize communication between the first terminal 10 and the second terminal 20 using a result of the comparison.

With this configuration, the same advantages effects as described regarding the communication system 1 can be achieved.

Moreover, a method of causing the server 30 to determine whether or not to authorize communication between the first terminal 10 and the second terminal 20 executed by the second terminal 20 includes: acquiring identifier information for a communication device capable of wirelessly communicating with the second terminal 20; and transmitting the identifier information to the server 30.

With this configuration, when the first identifier information is transmitted to the server 30 from the first terminal 10, the server 30 determines whether or not to authorize communication between the first terminal 10 and the second terminal 20.

### Embodiment 2

Embodiment 1 described above uses a configuration in which a communication device that is external to the communication system. In Embodiment 2 to be described hereinafter, a communication system capable of determining whether or not to authorize communication without using a communication device external to the communication system will be described.

### (2-1. Configuration)

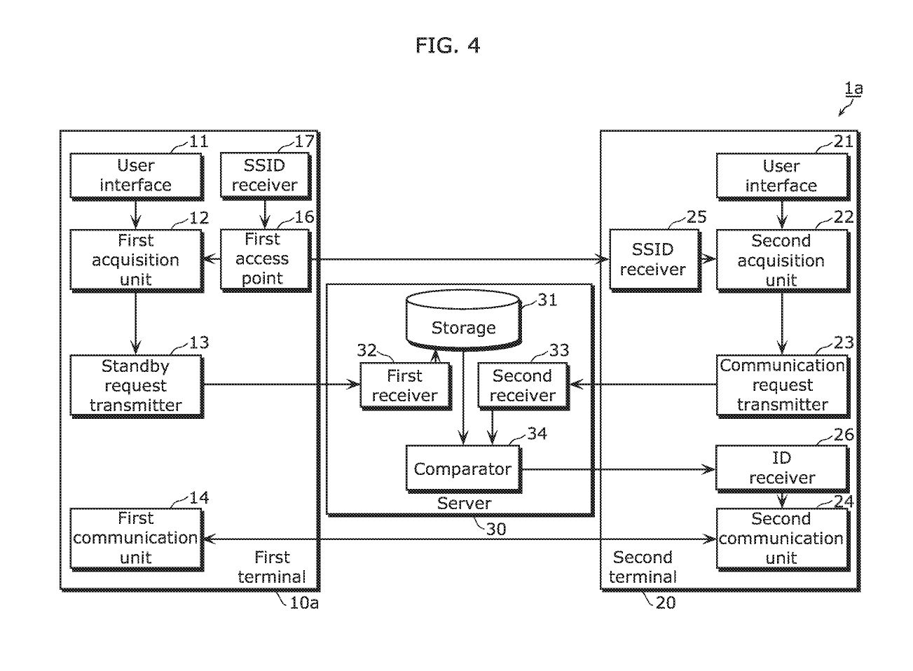

Hereinafter, a communication system according to Embodiment 2 will be described with reference to FIG. 4.

FIG. 4 is a block diagram illustrating characterizing functions performed by the communication system 1a according to this embodiment.

As illustrated in FIG. 4, this embodiment differs from Embodiment 1 in that this embodiment includes a first terminal 10a including an SSID generator 17 and a first access point 16.

The following will discuss the above difference.

The SSID generator 17 of the first terminal 10a is a processing unit that generates an SSID for the first access point 16 and outputs the generated SSID to the first access point 16. In the SSID generator 17, an SSID made up of an array of randomly selected characters, for example, is generated to greatly decrease the probability of duplicate SSIDs registered in the server 30.

The first access point 16 of the first terminal 10a is wireless LAN access point, and broadcasts the SSID input from the SSID generator 17. The first access point 16 also inputs the SSID into the first acquisition unit 12. The SSID broadcast by the first access point 16 is received by the SSID receiver 25 of the second terminal 20. Note that it is sufficient if the first access point 16 can broadcast the SSID; the first access point 16 does not need to include other features usually found in wireless LAN access points. Moreover, the SSID generator 17 may generate the SSID at predetermined intervals and may update the SSID of the first access point 16.

### (2-2. Operations)

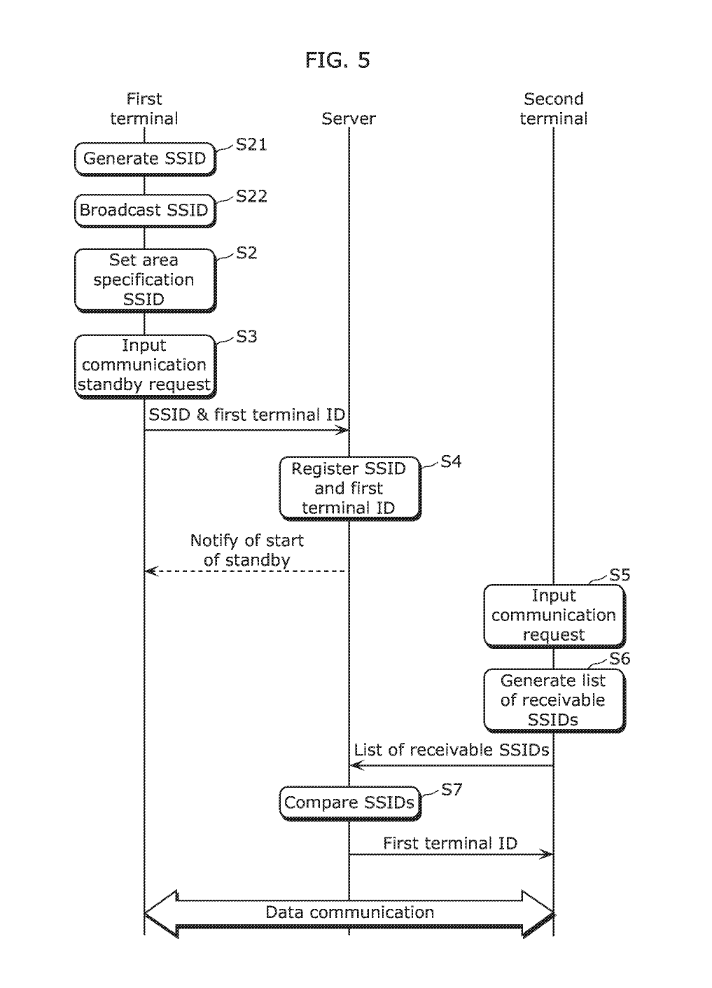

Next, operations performed by the communication system is according to this embodiment will be described with reference to FIG. 5, focusing on the differences between the operations performed by the communication system 1 according to Embodiment 1.

FIG. 5 is a sequence chart illustrating procedures for performing communication between the first terminal 10a and the second terminal 20 in the communication system 1a.

In the communication system is according to this embodiment, operations up to the setting of the area specification

SSID (S2), which is one example of the first identifier information, are different from operations performed by the communication system 1 according to Embodiment 1. Operations after the setting of the area specification SSID are the same as operations performed by the communication system 1 according to Embodiment 1. In this embodiment, an SSID is generated by the SSID generator 17 included in the first terminal 10a (S21). The generated SSID is input into the first access point 16 and broadcast as identifier information for the first access point 16 (S22). Then, the SSID is input into the first acquisition unit 12 from the first access point 16, and set as the area specification SSID (S2).

With this configuration, since an area in which terminals are authorized to communicate with the first terminal 10a can be specified as the area surrounding the first terminal 10a with certainty, it possible to sufficiently limit the terminals that are authorized to communicate with the first terminal 10a. Moreover, since it is possible to generate a random SSID in the SSID generator 17, it is possible to generate, with certainty, an SSID that does not match an SSID of, for example, another access point located near the communication system 1a.

(2-3. Advantageous Effects, etc.)

As described above, in the communication system is according to this embodiment, the first terminal 10a includes the first access point 16, and the first identifier information includes identifier information for the first access point 16. The comparator 34 determines to authorize communication between the first terminal 10a and the second terminal 20a when the second identifier information includes the identifier information for the first access point 16.

With this configuration, the comparator 34 can determine whether to authorize communication between the first terminal 10a and the second terminal 20 even when there is no access point near the communication system 1a.

Moreover, in the communication system 1a according to this embodiment, the first terminal 10a assigns an identifier to the first access point 16.

With this configuration, it is possible to generate, with certainty, an SSID that is different from an SSID that is the identifier for a nearby access point. This makes it possible to reduce the possibility of communication being authorized between the first terminal 10a and a terminal that should not be authorized to communicate with the first terminal 10a, and sufficiently limit the terminals that can communicate with the first terminal 10a.

Moreover, in the communication system 1a according to this embodiment, the first terminal 10a may modify an identifier of the first access point 16 when a given amount of time has elapsed.

This configuration makes it difficult for unauthorized communication with the first terminal 10a to occur. For example, this makes it possible to prevent the granting of authorization for communication with the first terminal 10a from outside the SSID reception area of the first access point 16 due to a terminal that was previously granted authorization to communicate with the first terminal 10a using the previously used first identifier information.

### Embodiment 3

In Embodiment 2 described above, a configuration in which the first terminal 10a includes the SSID generator 17 that generates an SSID for the first access point 16 is used. In Embodiment 3 to be described hereinafter, a configuration in which the SSID generator is included in the server will be described.

### (3-1. Configuration)

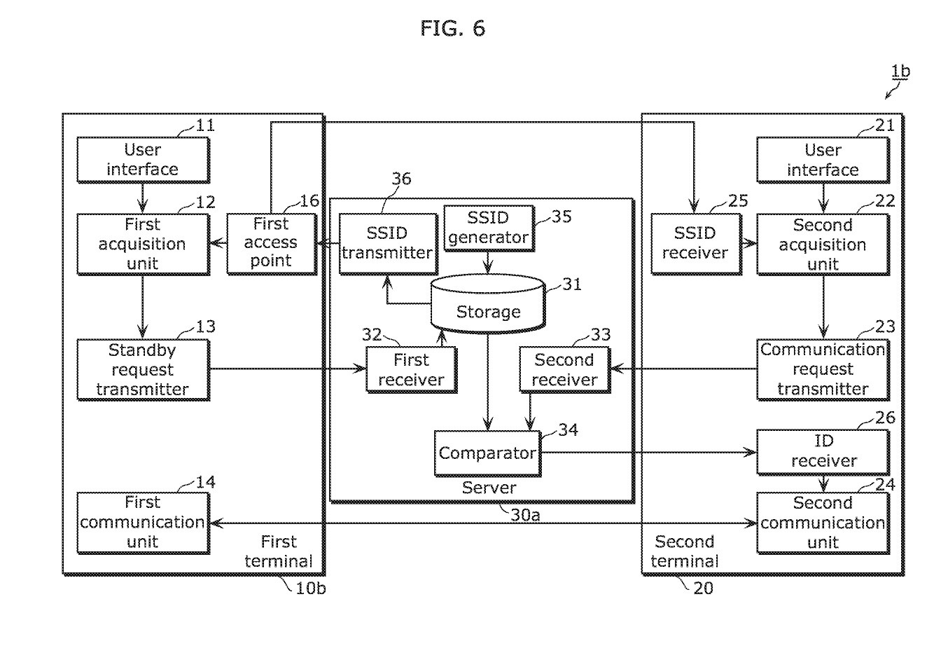

Hereinafter, a communication system 1b according Embodiment 3 will be described with reference to FIG. 6.

FIG. 6 is a block diagram illustrating characterizing functions performed by the communication system 1b according to this embodiment.

As described in FIG. 6, the present embodiment differs from Embodiment 2 in that, in the present embodiment, a server 30a includes a first terminal 10b instead of a SSID generator 35 including the first terminal 10b, and in that the server 30a includes an SSID transmitter 36 for transmitting, to the first terminal 10b, an SSID generated by the SSID generator 35.

The following will discuss the above differences.

The SSID generator 35 of the server 30a is a processing unit that generates an SSID for use in the first access point 16 of the first terminal 10b, and outputs the generated SSID to the storage 31 of the server 30a. Similar to the SSID generator 17 according to Embodiment 2, the SSID generator 35 can generate an SSID that is not the same as another SSID registered in the server 30a.

The storage 31 of the server 30a stores an SSID input from the SSID generator 35, and outputs an SSID to an SSID transmitter 36. Here, the storage 31 may output, to the SSID transmitter 36, the SSID input from the SSID generator 35 as-is, or may first store the SSID and then later output the stored SSID to the SSID transmitter 36. The storage 31 may further store a plurality of SSIDs input from the SSID generator 35, and select one of those SSIDs to output to the SSID transmitter 36. Moreover, the SSID generator 35 may generate new SSIDs at predetermined intervals, and the new SSID may be output to the SSID transmitter 36 from the storage 31.

The SSID transmitter 36 of the server 30a transmits, to the first access point 16 of the first terminal 10b, an SSID input from the storage 31.

### (3-2. Operations)

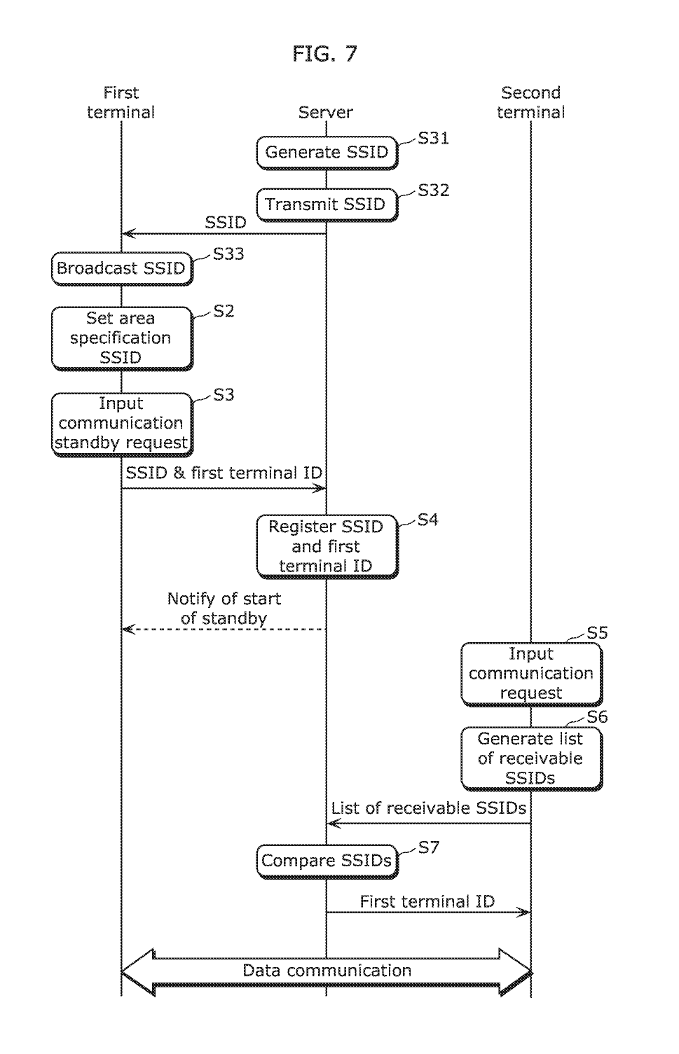

Next, operations performed by the communication system 1b according to this embodiment will be described with reference to FIG. 7, focusing on the differences between the operations performed by the communication system 1a according to Embodiment 2.

FIG. 7 is a sequence chart illustrating procedures for performing communication between the first terminal 10 and the second terminal 20 in the communication system 1b.

In the communication system 1b according to this embodiment, operations up to the setting of the area specification SSID (S2), which is one example of the first identifier information, are different from operations performed by the communication system 1a according to Embodiment 2. Operations after the setting of the area specification SSID are the same as operations performed by the communication system 1a according to Embodiment 2. In this embodiment, an SSID is generated by the SSID generator 35 included in the server 30a (S31). The SSID generated by the SSID generator 35 is input and stored in the storage 31 and subsequently output to the SSID transmitter 36 and transmitted by the SSID transmitter 36 to the first access point 16 (S32). The SSID is broadcast as identifier information for the first access point 16 (S33). Then, the SSID is input into the first acquisition unit 12 from the first access point 16, and set as the area specification SSID (S2).

### (3-3. Advantageous Effects, etc.)

As described above, in the communication system 1b according to this embodiment, the server 30a assigns an identifier to the first access point 16.

This configuration makes it possible to avoid duplication with an SSID registered in the server 30a. This makes it possible to reduce the possibility of communication being authorized between the first terminal 10b and a terminal that should not be authorized to communicate with the first terminal 10b, and sufficiently limit the terminals that can communicate with the first terminal 10b.

Moreover, in the communication system 1b according to this embodiment, the server 30a may include the storage 31 storing a plurality of different identifiers, and may assign one identifier among the plurality of different identifiers to the first access point 16.

This configuration makes it possible to avoid duplication with an SSID registered in the server 30a. This in turn makes it possible to reduce the possibility of communication being authorized between the first terminal 10b and a terminal that should not be authorized to communicate with the first terminal 10b.

Moreover, in the communication system 1b according to this embodiment, the server 30a may modify an identifier of the first access point 16 when a given amount of time has elapsed.

This configuration makes it difficult for unauthorized communication with the first terminal 10b to occur. For example, this makes it possible to prevent the granting of authorization for communication with the first terminal 10b from outside the SSID reception area of the first access point 16 due to a terminal that was previously granted authorization to communicate with the first terminal 10b using the previously used first identifier information.

### Other Embodiments

Embodiments 1 through 3 above are presented as examples of the techniques disclosed herein. However, the techniques disclosed herein are not limited to the above embodiments; various modifications, permutations, additions and omissions may also be implemented. Moreover, the elements described in Embodiments 1 through 3 may be combined to achieve new embodiments.

Examples of such embodiments will be described hereinafter.

In Embodiments 1 through 3, a communication device capable of wirelessly communicating with the first terminal or the second terminal is exemplified as a wireless LAN access point, and the identifier information is exemplified as an SSID, but the techniques of the present disclosure are not limited to these examples. For example, the communication device may be a base station of a mobile phone, and the identifier information may be an identifier of the base station.

Moreover, the first acquisition unit 12 and the second acquisition unit 22 according to Embodiment 1 may, in addition to identifier information, such as the SSID of the first communication device 40, acquire information pertaining to other wireless communication, and the information may be transmitted to the server 30 and compared by the comparator 34.

With this, only specific devices among devices in the area in which the SSID of the first communication device 40 is receivable can be authorized to communicate with the first terminal 10.

For example, in Embodiment 1, the first acquisition unit 12 and the second acquisition unit 22 according to Embodiment 1 may, in addition to the SSID of the first communication device 40, acquire SSID reception strengths of the SSID receiver 15 and the SSID receiver 25, and the acquired reception strengths may be compared in the comparator 34 of the server 30.

With this, in the comparator 34, in order to limit the terminals to be authorized to communicate with the first terminal 10 to those in the vicinity of the first communication device 40, it is possible to authorize only those terminals whose reception strength is greater than or equal to a given threshold to communicate with the first terminal 10.

Moreover, for example, when the first acquisition unit 12 of the first terminal 10 and the second acquisition unit 22 of the second terminal 20 according to Embodiment 1 are capable of acquiring the SSID of the second communication device 50 in addition to the SSID of the first communication device 40, both of these SSIDs may be compared in the comparator 34.

With this, only specific devices among devices in an overlapping area of the area in which the SSID of the first communication device 40 is receivable and the area in which the SSID of the second communication device 50 is receivable can be authorized to communicate with the first terminal 10.

Moreover, in Embodiment 2 and 3, the first terminal 10a and the first terminal 10b are exemplified as including the first access point 16, but the first access point 16 may be omitted in the first terminal 10a and 10b. When the first access point 16 is omitted, an SSID is generated in the first terminal 10a or in the server 30a, and the generated SSID is transmitted to the first access point 16. The first access point 16 that receives the SSID broadcasts the SSID.

This configuration achieves the same advantageous effects as Embodiment 2 and 3.

Each element in the above embodiments may be configured in the form of an exclusive hardware product, or may be realized by executing a software program suitable for the element. Each element may be realized by a program executing unit, such as a CPU or processor, reading and executing the software program recorded on a recording medium such as a hard disk or a semiconductor memory. Here, the software program for realizing the server and the second terminal according to the above embodiments is the program described below.

A program for realizing the server according to the above embodiments is a program that realizes, in a server, a method of determining, whether or not to authorize communication between a first terminal capable of communicating with the server and a second terminal capable of communicating with the server, the method including: receiving first identifier information for a given communication device and second identifier information for a communication device capable of wirelessly communicating with the second terminal; comparing the first identifier information and the second identifier information; and determining whether or not to authorize communication between the first terminal and the second terminal using a result of the comparison.

A program for realizing the second terminal according to the above embodiments is a program that realizes a method in a communication system including: a first terminal capable of communicating with a server; and a second terminal capable of communicating with the server, of causing the server to determine whether or not to authorize communication between the first terminal and the second terminal, the method being executed by the second terminal and including: acquiring identifier information for a communication device capable of wirelessly communicating with the second terminal; and transmitting the identifier information to the server.

Moreover, the block diagrams illustrate one example of the division of functional blocks; a plurality of functional blocks may be realized as a single functional block, a single functional block may be broken up into a plurality of functional blocks, and part of one function may be transferred to another functional block. Moreover, a plurality of functional blocks which share similar functions can be processed by standalone hardware or software in parallel or time-shared.

Moreover, the order in which the steps included in the methods according to the above embodiments are executed are mere examples in order to specifically describe the present disclosure, and may include orders other than those described above. Moreover, some of the steps may be executed at the same time as (in parallel with) other steps.

### INDUSTRIAL APPLICABILITY

The present disclosure is applicable in systems including a server and a plurality of terminals capable of communicating with the server. More specifically, the present disclosure can be applied in, for example, a system including a terminal such as a lecturer's PC in a lecture room, a terminal such as a smartphone belonging to an audience member, and a server capable of communicating with the terminals.

1. A communication system, comprising:
a server;
a first terminal including a first access point and capable of communicating with the server; and
a second terminal capable of communicating with the server,
wherein the first terminal includes a first acquisition unit configured to acquire first identifier information for a given communication device,
the second terminal includes a second acquisition unit configured to acquire second identifier information for a communication device capable of wirelessly communicating with the second terminal,
the server includes:
a first receiver that receives the first identifier information from the first terminal;
a second receiver that receives the second identifier information from the second terminal; and
a comparator that compares the first identifier information and the second identifier information and, using a result of the comparison, determines whether or not to authorize communication between the first terminal and the second terminal, and
when the comparator determines to authorize communication between the first terminal and the second terminal, the comparator transmits, to at least one of the first terminal and the second terminal, information to be used for communicating with the other of the first terminal and the second terminal.

2. The communication system according to claim 1, wherein the second identifier information includes identifier information for a plurality communication devices capable of wirelessly communicating with the second terminal.

3. The communication system according to claim 1, wherein the first identifier information and the second identifier information each include identifier information for an access point.

4. The communication system according to claim 1, wherein
the first identifier information includes identifier information for the first access point, and
the comparator determines to authorize communication between the first terminal and the second terminal when the second identifier information includes the identifier information for the first access point.

5. The communication system according to claim 1, wherein the first terminal assigns an identifier to the first access point.

6. The communication system according to claim 1, wherein the first terminal modifies an identifier of the first access point when a given amount of time has elapsed.

7. The communication system according to claim 1, wherein the server includes a storage storing a plurality of different identifiers, and assigns one identifier among the plurality of different identifiers to the first access point.

8. The communication system according to claim 1, wherein the server modifies an identifier of the first access point when a given amount of time has elapsed.

9. The communication system according to claim 1, wherein
the first acquisition unit is further configured to acquire first communication information pertaining to wireless communication,
the second acquisition unit is further configured to acquire second communication information pertaining to wireless communication, and
the comparator determines whether or not to authorize communication between the first terminal and the second terminal using (i) a result of the comparison of the first identifier information and the second identifier information and (ii) the first communication information and the second communication information.

10. The communication system according to claim 9, wherein
the first identifier information is identifier information for a communication device capable of wirelessly communicating with the first terminal,
the first communication information is a reception strength from a communication device capable of wirelessly communicating with the first terminal,
the second communication information is a reception strength from a communication device capable of wirelessly communicating with the second terminal, and
the comparator determines to authorize communication between the first terminal and the second terminal when (i) the comparator detects a communication device whose identifier information includes information included in the first identifier information and the second identifier information and (ii) the first communication information and the second communication information pertaining to the detected communication device are greater than or equal to a given threshold.

11. The communication system according to claim 9, wherein
the first communication information is identifier information for a communication device capable of wirelessly communicating with the first terminal, and is different from the first identifier information,
the second communication information is identifier information for a communication device capable of wirelessly communicating with the second terminal, and is different from the second identifier information, and
the comparator compares the first communication information and the second communication information in addition to comparing the first identifier information and the second identifier information.

12. The communication system according to claim 1, wherein the second terminal comprises a plurality of second terminals, and the server determines to authorize communication between the first terminal and a given number of the plurality of second terminals.

13. A server communicably connected to a first terminal and a second terminal, the server comprising:
a first receiver that receives, from the first terminal, first identifier information for a given communication device;
a second receiver that receives, from the second terminal, second identifier information for a communication device capable of wirelessly communicating with the second terminal; and
a comparator that compares the first identifier information and the second identifier information and, using a result of the comparison, determines whether or not to authorize communication between the first terminal and the second terminal,
wherein when the comparator determines to authorize communication between the first terminal and the second terminal, the comparator transmits, to at least one of the first terminal and the second terminal, information to be used for communicating with the other of the first terminal and the second terminal, and
wherein the first terminal includes a first access point.

14. A method, executed in a server, of determining whether or not to authorize communication between a first terminal capable of communicating with the server and a second terminal capable of communicating with the server, the method comprising:
receiving first identifier information for a given communication device and second identifier information for a communication device capable of wirelessly communicating with the second terminal;
comparing the first identifier information and the second identifier information; and
determining whether or not to authorize communication between the first terminal and the second terminal using a result of the comparison,
wherein the first terminal includes a first access point.

15. A non-transitory computer-readable recording medium for use in a computer, the recording medium having a computer program recorded thereon for causing the server to execute the method according to claim 14.

16. A method in a communication system including: a first terminal capable of communicating with a server; and a second terminal capable of communicating with the server, of causing the server to determine whether or not to authorize communication between the first terminal and the second terminal, the method being executed by the second terminal and comprising:
acquiring identifier information for a communication device capable of wirelessly communicating with the second terminal; and
transmitting the identifier information to the server,
wherein the first terminal includes a first access point.

17. A non-transitory computer-readable recording medium for use in a computer, the recording medium having a computer program recorded thereon for causing the second terminal to execute the method according to claim 16.
